(19) United States
(12) Patent Application Publication
(10) Pub. No.: US 2003/0206505 A1
(43) Pub. Date: Nov. 6, 2003

(54) Optical disk drive with a servo control system

(75) Inventors: Han-Wen Hsu, Hsinchu City (TW); Chao-Ming Huang, Changhua City (TW); Chih-Yuan Chen, Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Media Tek Inc.

(21) Appl. No.: 10/293,796

(22) Filed: Nov. 12, 2002

(30) Foreign Application Priority Data
May 1, 2002 (TW) 091109086

(51) Int. Cl. G11B 7/095

(52) U.S. Cl. 369/44.35

(57) ABSTRACT

An optical disk drive includes an optical pickup unit, a tracking coil motor and a sled motor that drive movement of the optical pickup unit, and a servo control system. The optical pickup generates a tracking error signal indicative of amount of shift of the optical pickup unit relative to a track position of an optical disk, and a central error signal indicative of amount of shift of the optical pickup unit relative to an optical path. The servo control system generates a tracking coil control signal based on the tracking error signal for controlling operation of the tracking coil motor to adjust the optical pickup unit relative to the track position of the optical disk, and generates a sled motor control signal based on the central error signal for controlling operation of the sled motor to adjust the optical pickup unit relative to the optical path.

### CROSS-REFERENCE TO RELATED APPLICATION

This application claims priority of Taiwanese application no. 091109086, filed on May 1, 2002.

### BACKGROUND OF THE INVENTION

1. Field of the Invention

The invention relates to an optical disk drive, more particularly to an optical disk drive with a servo control system for adjusting an optical pickup unit of the optical disk drive.

2. Description of the Related Art

Referring to FIG. 1, a conventional optical disk drive 1 is adapted to be loaded with an optical disk 12 and is shown to include an optical pickup unit 11, a spindle motor 13 for driving rotation of the optical disk 12, a sled motor 14 and a tracking coil motor 15 for driving movement of the optical pickup unit 11, a preamplifier 10, a power driver 16, and a digital signal processor 17. The digital signal processor 17 provides servo control functions, and includes a tracking coil servo control unit 172, a rule database 173 and a sled motor servo control unit 174.

Because the optical disk drive 1 accesses data of the optical disk 12 by the interaction of incident and reflected light beams, it is essential that the optical pickup unit 11 must be accurately moved and aligned with a target track on the optical disk 12 during data access. Track alignment of the optical pickup unit 11 is first conducted by the driving operations of the sled motor 14 and the tracking coil motor 15, followed by the rotation of the optical disk 12 through the spindle motor 13. The optical pickup unit 11 is used for reading data from the optical disk 12 or writing data to the optical disk 12. During reading, data stored in the optical disk 12 and relevant servo control information will be converted by the optical pickup unit 11 into electrical signals that are provided to and that are amplified by the preamplifier 10. Signals from the preamplifier 10 include a data signal and a tracking error signal (TE) (i.e., the aforesaid relevant servo control information). The data signal will be decoded by the optical disk drive 1 to retrieve the contents of the optical disk 12. On the other hand, the tracking error signal (TE) will be provided to the digital signal processor 17 to enable the latter to control operations of the sled motor 14 and the tracking coil motor 15. A detailed description of how the digital signal processor 17 controls the sled motor 14 and the tracking coil motor 15 is provided in the following paragraphs.

Initially, the tracking coil servo control unit 172 of the digital signal processor 17 receives the tracking error signal (TE) and generates a tracking coil control signal (TRO) after performing relevant operations on the tracking error signal (TE) based on data in the rule database 173. The tracking coil control signal (TRO) is provided to the power driver 16 and the sled motor servo control unit 174. Thereafter, the sled motor servo control unit 174 will generate a sled motor control signal (FMO) from the tracking coil control signal (TRO) and provides the sled motor control signal (FMO) to the power driver 16. Finally, the power driver 16 controls the tracking coil motor 15 and the sled motor 14 based on the tracking coil control signal (TRO) and the sled motor control signal (FMO), respectively, such that the optical pickup unit 11 will be moved to the intended position of the target track accordingly.

The optical pickup unit 11 generally includes a light source, an objective lens for focusing light from the light source onto the optical disk 12, and a light sensor for sensing light reflected from the optical disk 12. When the optical disk drive 1 is used for reading data, the light source will provide a light beam that passes through the objective lens so as to be incident upon a track on the optical disk 12. The optical disk 12 then reflects the light beam to pass once again through the objective lens for reception by the light sensor. The amount of reflected light indicates the state (i.e., 0 or 1) of data stored in the track of the optical disk 12. Thus, the light sensor will convert the detected amount of reflected light into a corresponding voltage or current signal that is provided to the digital signal processor 17 for subsequent decoding and data retrieval. Therefore, to ensure accurate operation of the optical disk drive 1, the accuracy of optical paths formed therein is essential. For instance, recording of data occurs in the center of the tracks of the optical disk 12. This mandates that reading of data by the optical pickup unit 11 must also proceed in the center of the tracks of the optical disk 12. Otherwise, reading of data cannot be effected, or data reading error can occur. Thus, aside from providing the function of sensing data signals, the light sensor also provides a further function of sensing optical paths. For example, the tracking error signal (TE) is used as an indication of the amount of shift or tilt of the optical pickup unit 11 relative to a center of a track of the optical disk 12. By virtue of the tracking error signal (TE), the digital signal processor 17 can control the tracking coil motor 15 and the sled motor 14 so that the optical pickup unit 11 can be aligned with the center of the track of the optical disk 12. As shown in FIG. 2, an optical path 18 for data access includes a first portion 181 extending from the objective lens 111 to an optical disk track 121 (relevant to whether the optical pickup unit 11 is aligned with the center of the optical disk track 121), and a second portion 182 extending from the objective lens 11 to the light sensor 112. Thus, for accurate data reading, the objective lens 111 must be positioned in the center of the optical path 18 (i.e., the optical axis of the light sensor 112). However, there are many factors that could cause the objective lens 111 to deviate from the optical axis of the light sensor 112, such as vibration displacement of the optical pickup unit 11, unbalanced voltage output from the power driver 16, machine assembly errors, metal fatigue, elastic deformation, etc. Therefore, the digital signal processor 17 provides the function of controlling the sled motor 14 to adjust the objective lens 111 for alignment with the center of the optical path 18.

In the conventional optical disk drive 1, the sled motor servo control unit 174 relies upon the tracking coil control signal (TRO) when generating the sled motor control signal (FMO) for controlling the sled motor 14. On the other hand, the tracking coil servo control unit 172 requires the tracking error signal (TE) when generating the tracking coil control signal (TRO) Therefore, the sled motor control signal (FMO) can be considered as being formed as a direct result of the tracking error signal (TE). During low-frequency vibration displacement of the optical pickup unit 11, there is a rather high correlation between the vibration displacement of the objective lens 111 and the tracking error signal (TE), and highly accurate correction can be performed. However, during high-frequency vibration of the optical pickup unit 11, the correlation between the vibration displacement of the objective lens 111 and the tracking error signal (TE) will become rather complicated, and highly accurate correction will be hard to achieve. Furthermore, with reference to FIG. 2, the tracking error signal (TE) is only indicative of the shift or tilt of the objective lens 111 relative to the center of an optical disk track 121. If an error is due to a shift or tilt of the objective lens 111 relative to the center of the optical path 18 as a result of external forces, such as unbalanced voltage output from the power driver 16, machine assembly errors, machine metal fatigue, elastic deformation, etc., no such relevant information will be provided to the sled motor servo control unit 174 so that the sled motor control signal (FMO) generated thereby cannot be relied upon for appropriate correction of the objective lens 111. In other words, due to lack of an error signal that represents the amount of shift or tilt of the objective lens 111 relative to an optical axis of the light sensor 112, appropriate optical path correction cannot be performed in the conventional optical disk drive 1. Such kinds of errors affect greatly data access quality of optical disks, even to the extent of illegibility, and can affect quality and service life of optical disk drives. Therefore, as to how shifting or tilting of the objective lens relative to the center of an optical path and attributed to the aforesaid external forces can be corrected is an important topic in the industry.

### SUMMARY OF THE INVENTION

Therefore, the main object of the present invention is to provide an optical disk drive with a servo control system that can overcome the aforesaid drawbacks of the prior art.

Accordingly, an optical disk drive of this invention is adapted to be loaded with an optical disk, and comprises:

an optical pickup unit for reading the optical disk, the optical pickup unit generating a tracking error signal indicative of amount of shift of the optical pickup unit relative to a track position of the optical disk, and a central error signal indicative of amount of shift of the optical pickup unit relative to an optical path;

a tracking coil motor and a sled motor coupled to the optical pickup unit for driving movement of the optical pickup unit relative to the optical disk; and

a servo control system coupled to the optical pickup unit for receiving the tracking error signal and the central error signal therefrom, the servo control system generating a tracking coil control signal based on the tracking error signal for controlling operation of the tracking coil motor to adjust the optical pickup unit relative to the track position of the optical disk, and further generating a sled motor control signal based on the central error signal for controlling operation of the sled motor to adjust the optical pickup unit relative to the optical path.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional optical disk drive;

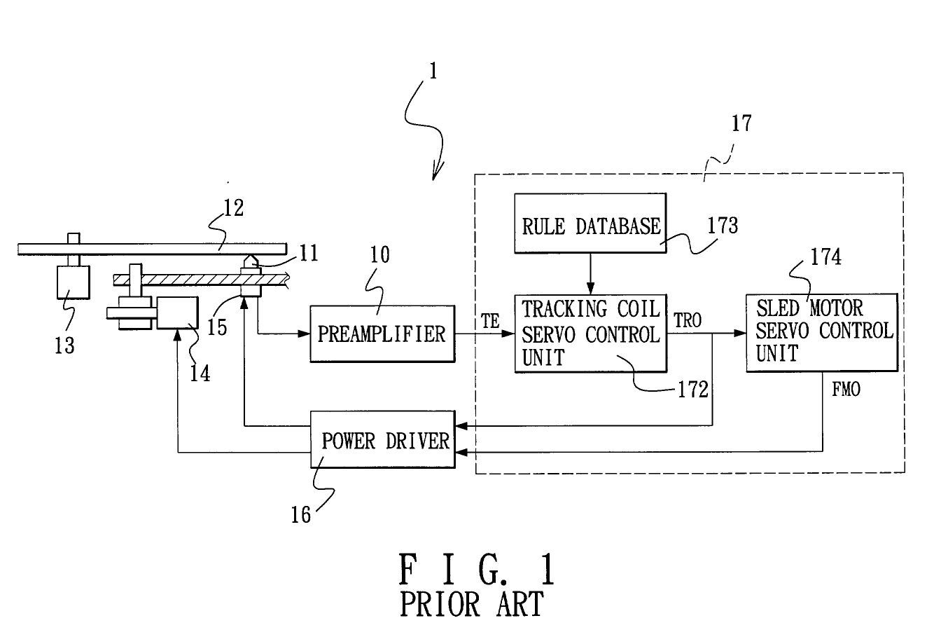

FIG. 2 is a schematic diagram illustrating positions of an objective lens and a light sensor relative to an optical disk track in the conventional optical disk drive of FIG. 1;

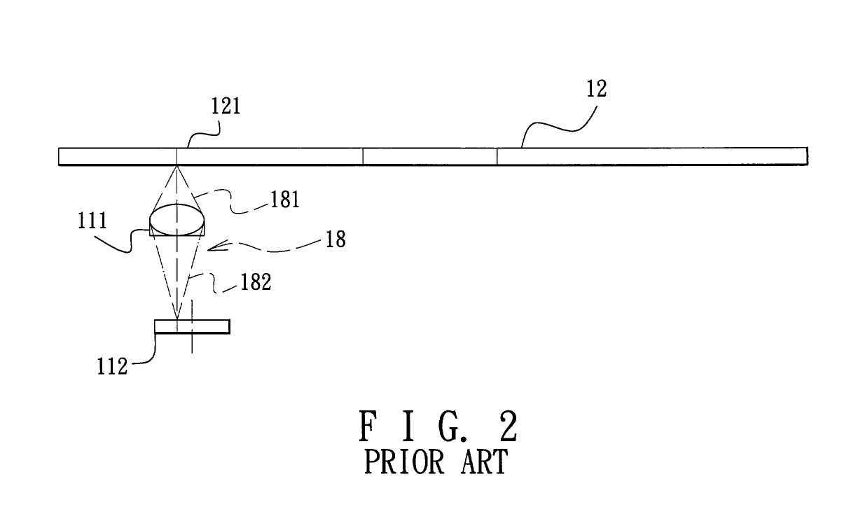

FIG. 3 is a schematic diagram of a preferred embodiment of an optical disk drive with a servo control system according to the present invention; and

FIG. 4 is a schematic diagram illustrating how a tracking error signal and a central error signal are generated in an optical pickup unit of the preferred embodiment.

### DETAILED DESCRIPTION OF THE PREFERRED EMBODIMENT

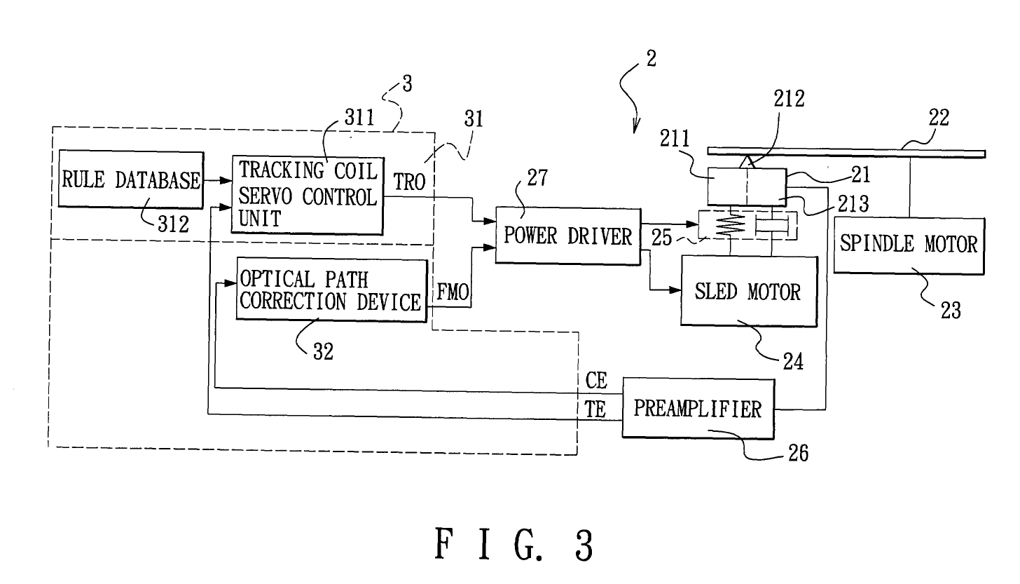

Referring to FIG. 3, the preferred embodiment of an optical disk drive 2 according to the present invention is adapted to be loaded with an optical disk 22, and is shown to include an optical pickup unit 21 for reading the optical disk 22, a spindle motor 23 for driving rotation of the optical disk 22, a sled motor 24 and a tracking coil motor 25 coupled to the optical pickup unit 21 for driving movement of the optical pickup unit 21, a preamplifier 26 coupled to the optical pickup unit 21, a power driver 27 coupled to the sled motor 24 and the tracking coil motor 25, and a servo control system 3 coupled to the power driver 27 and the preamplifier 26.

The optical pickup unit 21 includes a light source 211 for providing a light beam to the optical disk 22, an objective lens 212 for focusing light from the light source 211 onto the optical disk 22, and a light sensor 213 for sensing light reflected from the optical disk and for converting reflected light sensed thereby into electrical signals that are provided to the preamplifier 26 for amplification. The light source 211 can be a laser light source.

In this embodiment, the electrical signals include at least a data signal, a tracking error signal (TE), and a central error signal (CE). The tracking error signal (TE) and the central error signal (CE) are provided to the servo control system 3, which generates a tracking coil control signal (TRO) and a sled motor control signal (FMO) that are outputted to the power driver 27. The power driver 27 will drive the tracking coil motor 25 and the sled motor 24 according to the tracking coil control signal (TRO) and the sled motor control signal (FMO), respectively, so as to move the optical pickup unit 21 to a target track of the optical disk 22 and to maintain alignment of the optical pickup unit 21 with both the center of the target track and that of an optical path. Since the processing of data signals and the manner in which the tracking coil control signal (TRO) and the sled motor control signal (FMO) control the tracking coil motor 25 and the sled motor 24 for driving movement of the optical pickup unit 21 are known to those skilled in the art, a detailed description of the same will not be provided herein for the sake of brevity.

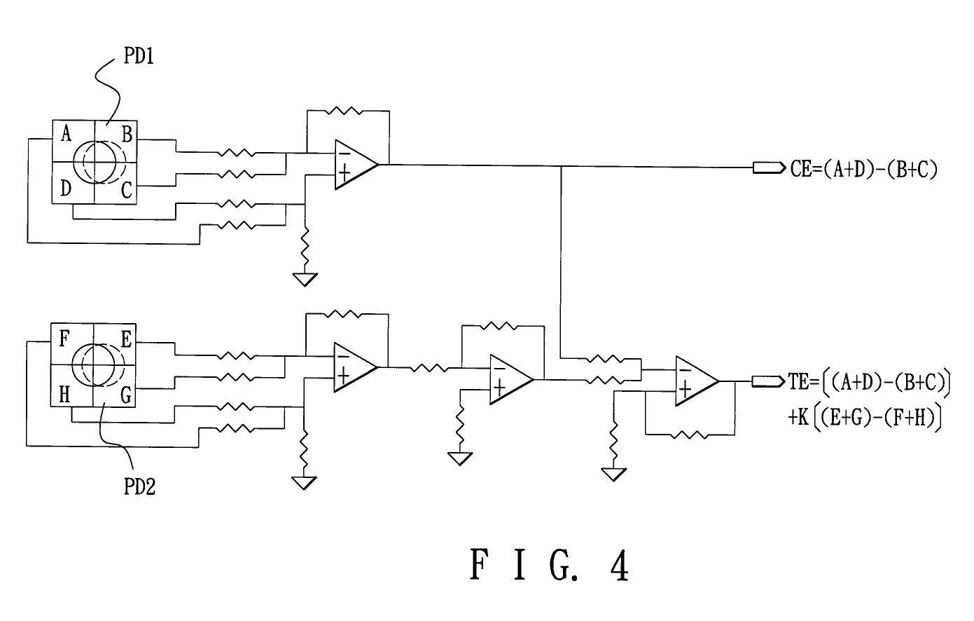

The tracking error signal (TE) indicates the amount of shift or tilt of the objective lens 211 relative to a center of a track of the optical disk 22. The central error signal (CE) indicates the amount of shift or tilt of the objective lens 211 relative to a center of an optical path (i.e., the optical axis of the light sensor 213). FIG. 4 is a schematic diagram of the light sensor 213 to illustrate how the tracking error signal (TE) and the central error signal (CE) are generated. In this embodiment, the light sensor 213 includes first and second light sensor units (PD1, PD2). The first light sensor unit (PD1) is subdivided into four areas (A, B, C, D) for sensing primary light falling points of a reflected light beam. The second light sensor unit (PD2) is subdivided into four areas (E, F, G, H) for sensing secondary light falling points of the reflected light beam. Since the primary and secondary light falling points are found in different positions of the first and second light sensor units (PD1, PD2), the different areas (A, B, C, D, E, F, G, H) will detect different intensities of reflected light, and will output corresponding voltage signals accordingly. The voltage signals are combined through a plurality of negative feedback amplifiers to result in the tracking error signal (TE) and the central error signal (CE), wherein the central error signal (CE) is equal to [(A+D)−(B+C)], and the tracking error signal (TE) is equal to [(A+D)−(B+C)]+K[(E+G)−(F+H)], where K is a gain coefficient. It should be noted here that it is feasible for one skilled in the art to adjust the order of the amplifiers or even to replace the amplifiers with other components to implement the aforesaid arithmetic operations.

The servo control system 3 is used to control operations of the tracking coil motor 25 and the sled motor 24 according to the tracking error signal (TE) and the central error signal (CE) for adjusting the optical pickup unit 21 to maintain alignment with the center of a track of the optical disk 22 and with the center of the optical path. In this embodiment, the servo control system 3 includes a tracking correction device 31 and an optical path correction device 32. The tracking correction device 31 is used to ensure alignment of the objective lens 211 relative to the center of the track of the optical disk 22, and includes a tracking coil servo control unit 311 and a rule database 312. The tracking coil servo control unit 311 is coupled to the preamplifier 26 and the power driver 27. The rule database 312 is coupled to the tracking coil servo control unit 311 and stores a tracking compensation algorithm therein. The tracking coil servo control unit 311 receives the tracking error signal (TE) from the preamplifier 26, and processes the tracking error signal (TE) according to the tracking compensation algorithm stored in the rule database 312 so as to generate the tracking coil control signal (TRO) that is provided to the power driver 27. The optical path correction device 32 is used to ensure alignment of the objective lens 211 with the center of the optical path. The optical path correction device 32 is coupled to the preamplifier 26 and the power driver 27, receives the central error signal (CE) from the preamplifier 26, and processes the central error signal (CE) so as to generate the sled motor control signal (FMO) that is provided to the power driver 27. When the power driver 27 receives the tracking coil control signal (TRO) and the sled motor control signal (FMO) from the tracking correction device 31 and the optical path correction device 32, the power driver 27 will drive the tracking coil motor 25 and the sled motor 24 accordingly so as to adjust the position of the objective lens 211. In this embodiment, since the optical path correction device 32 generates the sled motor control signal (FMO) based on the central error signal (CE), and since the central error signal (CE) indicates the amount of shift or tilt of the objective lens 211 relative to an optical axis of the light sensor 213 in real-time, the correlation between the amount of shift or tilt of the objective lens 211 relative to the optical path and the sled motor control signal (FMO) is accordingly simplified for quick and easy optical path correction. At the same time, the tracking correction device 31 will generate an appropriate tracking coil control signal (TRO) to maintain proper alignment of the objective lens 211 relative to the center of the track of the optical disk 22. As such, alignment of the objective lens 211 with the center of the track of the optical disk 22 and the center of the optical path (i.e., the optical axis of the light sensor 213) can be ensured in the optical disk drive 2 of this invention. The above description focuses mainly on how the tracking correction device ensures alignment of the objective lens relative to the center of a track of the optical disk, and how the optical path correction device ensures alignment of the objective lens with the center of the optical path. The description as such is directed to the tracking mode of the optical disk drive. As a matter of fact, in order for the optical disk drive to operate in a normal way, the control of the tracking coil motor and the sled motor during the seeking process is just as important as that during the tracking mode. If good alignment of the objective lens with the center of the optical path cannot be achieved at the end of the seeking process, this can probably result in that switching from the seeking mode to the tracking mode will be out of control, and that subsequent read or write operation of the optical disk drive will be improper. The alignment problem in the seeking mode is thus the same as that in the tracking mode. The utility of the technique employed in the present invention can be extended to cases involving long seeking or short seeking. In the case of long seeking or short seeking, the tracking coil control signal (TRO) is still generated from the tracking error signal (TE) although the rule database for the tracking coil servo control will be different from that in the tracking mode, and the sled motor control signal (FMO) is generated in the same manner from the central error signal (CE). In general, the purpose of the rule database in the seeking mode is to provide a velocity profile for the objective lens to follow. The velocity of the objective lens is easily obtained by counting the frequency of the tracking error signal (TE). At the same time, the sled motor will be driven according to the amount of misalignment of the objective lens relative to the center of the optical path. Therefore, the alignment of the objective lens with the center of the optical path can be guaranteed as well during the long seeking or short seeking process.

When compared with the aforesaid conventional optical disk drive 1, which generates the sled motor control signal (FMO) from the tracking coil control signal (TRO), the inclusion of the central error signal (CE) from which the optical path correction device 32 generates the sled motor control signal (FMO) in the optical disk drive 2 of this invention results in the following advantages:

1. Shifting or tilting of the objective lens relative to the center of the optical path can be corrected. The problem of complicated correlation between high-frequency vibration displacement of the objective lens and the tracking error signal (TE) is not only resolved, errors due to shifting or tilting of the objective lens relative to the center of the optical path caused by external forces, such as unbalanced voltage output from the power driver, machine assembly errors, machine metal fatigue, elastic deformation, etc., are also corrected.

2. Data access can be conducted in a more effective manner. Since undesired shifting or tilting of the optical pickup unit can be accurately corrected in the optical disk drive of this invention, the effectiveness of data access can be ensured, and the service life of the optical disk drive can be extended as well.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An optical disk drive adapted to be loaded with an optical disk, said optical disk drive comprising:
an optical pickup unit for reading the optical disk, said optical pickup unit generating a tracking error signal indicative of amount of shift of said optical pickup unit relative to a track position of the optical disk, and a central error signal indicative of amount of shift of said optical pickup unit relative to an optical path;
a tracking coil motor and a sled motor coupled to said optical pickup unit for driving movement of said optical pickup unit relative to the optical disk; and
a servo control system coupled to said optical pickup unit for receiving the tracking error signal and the central error signal therefrom, said servo control system generating a tracking coil control signal based on the tracking error signal for controlling operation of said tracking coil motor to adjust said optical pickup unit relative to the track position of the optical disk, and further generating a sled motor control signal based on the central error signal for controlling operation of said sled motor to adjust said optical pickup unit relative to the optical path.

2. The optical disk drive as claimed in claim 1, wherein said optical pickup unit includes a light source, an objective lens for focusing light from said light source onto the optical disk, and a light sensor for sensing light reflected from the optical disk.

3. The optical disk drive as claimed in claim 2, wherein the tracking error signal indicates the amount of shift of said objective lens relative to a center of a track of the optical disk.

4. The optical disk drive as claimed in claim 2, wherein the central error signal indicates the amount of shift of said objective lens relative to an optical axis of said light sensor.

5. The optical disk drive as claimed in claim 1, further comprising a preamplifier that interconnects said optical pickup unit and said servo control system and that provides the tracking error signal and the central error signal from said optical pickup unit to said servo control system.

6. The optical disk drive as claimed in claim 1, wherein said servo control system includes a tracking correction device coupled to said optical pickup unit for receiving the tracking error signal therefrom, said tracking correction device generating the tracking coil control signal for controlling operation of said tracking coil motor.

7. The optical disk drive as claimed in claim 6, wherein said tracking correction device includes a tracking coil servo control unit coupled to said optical pickup unit for receiving the tracking error signal therefrom, and a rule database coupled to said tracking coil servo control unit for storing a tracking compensation algorithm therein, said tracking coil servo control unit processing the tracking error signal according to the tracking compensation algorithm stored in said rule database so as to generate the tracking coil control signal.

8. The optical disk drive as claimed in claim 1, wherein said servo control system includes an optical path correction device coupled to said optical pickup unit for receiving the central error signal therefrom, said optical path correction device generating the sled motor control signal for controlling operation of said sled motor.

9. The optical disk drive as claimed in claim 1, further comprising a power driver that connects said tracking coil motor and said sled motor to said servo control system, said power driver receiving the tracking coil control signal and the sled motor control signal from said servo control system, and controlling operations of said tracking coil motor and said sled motor according to the tracking coil control signal and the sled motor control signal, respectively.

10. An optical disk drive adapted to be loaded with an optical disk, said optical disk drive comprising:
an optical pickup unit for reading the optical disk, said optical pickup unit generating a central error signal indicative of amount of shift of said optical pickup unit relative to an optical path;
a sled motor coupled to said optical pickup unit for driving movement of said optical pickup unit relative to the optical disk; and
a servo control system coupled to said optical pickup unit for receiving the central error signal therefrom, said servo control system generating a sled motor control signal based on the central error signal for controlling operation of said sled motor to adjust said optical pickup unit relative to the optical path.

11. The optical disk drive as claimed in claim 10, wherein said optical pickup unit includes a light source, an objective lens for focusing light from said light source onto the optical disk, and a light sensor for sensing light reflected from the optical disk.

12. The optical disk drive as claimed in claim 11, wherein the central error signal indicates the amount of shift of said objective lens relative to an optical axis of said light sensor.

13. A servo control system for an optical disk drive, the optical disk drive being adapted to be loaded with an optical disk and including an optical pickup unit for reading the optical disk, and a tracking coil motor and a sled motor coupled to the optical pickup unit for driving movement of the optical pickup unit relative to the optical disk, the optical pickup unit generating a tracking error signal indicative of amount of shift of the optical pickup unit relative to a track position of the optical disk, and a central error signal indicative of amount of shift of the optical pickup unit relative to an optical path, said servo control system comprising:
a tracking correction device adapted to be coupled to the optical pickup unit for receiving the tracking error signal therefrom, said tracking correction device generating a tracking coil control signal based on the tracking error signal for controlling operation of the tracking coil motor to adjust the optical pickup unit relative to the track position of the optical disk; and
an optical path correction device adapted to be coupled to the optical pickup unit for receiving the central error signal therefrom, said optical path correction device generating a sled motor control signal based on the central error signal for controlling operation of the sled motor to adjust the optical pickup unit relative to the optical path.

14. The servo control system as claimed in claim 13, wherein said tracking correction device includes a tracking coil servo control unit adapted to be coupled to the optical pickup unit for receiving the tracking error signal therefrom, and a rule database coupled to said tracking coil servo control unit for storing a tracking compensation algorithm therein, said tracking coil servo control unit being adapted to process the tracking error signal according to the tracking compensation algorithm stored in said rule database so as to generate the tracking coil control signal.
